(19) United States
(12) Patent Application Publication
(10) Pub. No.: US 2009/0244361 A1
(43) Pub. Date: Oct. 1, 2009

(54) CAMERA MODULE FOR VEHICLE VISION SYSTEM

(75) Inventors: Duane W. Gebauer, Gregory, MI (US); Joel S. Gibson, Linden, MI (US); Shih-Che Huang, Grand Blanc, MI (US); Hugh W. Ireland, Clio, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: MAGNA ELECTRONICS INC., Holly, MI (US)

(21) Appl. No.: 12/091,359

(22) PCT Filed: Oct. 27, 2006
(86) PCT No.: PCT/US06/41709

§ 371 Date: Jun. 10, 2008

Related U.S. Application Data
(60) Provisional application No. 60/731,183, filed on Oct. 28, 2005.

(51) Int. Cl. H04N 5/225

(52) U.S. Cl. 348/373; 348/E05.024

(57) ABSTRACT

A camera module (10) for a vision system of a vehicle includes a circuit element (12), a lens mounting element (14b, 14c), a lens assembly (14) and an outer shell or cover portion (16). The circuit element includes an imaging sensor and associated circuitry (12a). The lens assembly includes at least one optical element (14a) and the lens mounting element (14b, 14c) is attached to the circuit element (12) so as to provide an optical path through the optical element to the imaging sensor at the circuit element. The outer shell (16) is molded over and around the circuit element during a molding process to substantially encapsulate the circuit element within the outer shell. The module and method of making the module thus may substantially seal the circuit element within the overmolded outer shell to protect the circuit element from exposure to the elements.

### CROSS REFERENCE TO RELATED APPLICATION

The present application claims the benefit of U.S. provisional application Ser. No. 60/731,183, filed Oct. 28, 2005 (Attorney Docket DON01 P-1248), which is hereby incorporated herein by reference in its entirety.

### FIELD OF THE INVENTION

The present invention relates generally to the field of vision systems for vehicles and, more particularly, to visions systems that include one or more imaging sensor positioned at the vehicle and having an interior or exterior field of view.

### BACKGROUND OF THE INVENTION

The advent of low cost, reliable imaging devices, based on a variety of silicon technologies, and in particular CMOS technology, combined with an improved cost/performance ratio for displays capable of meeting automotive specifications, and an increasing application rate of video monitor displays for automotive navigation systems or as part of the driver interface to a wide variety of vehicle systems, has lead to an increasing use of cameras or imaging sensors designed to give the driver a view of those areas around the vehicle which are not in the normal direct field of view of the driver, typically referred to as “blind spots”. These areas include the region close to the front of the vehicle, typically obscured by the forward structure of the vehicle, the region along the passenger side of the vehicle, the region along the driver's side of the vehicle rearward of the driver, and the area or region immediately rearward of the vehicle which cannot be seen directly or indirectly through the rear view mirror system. The camera or imaging sensor may capture an image of the rearward (or sideward or other blind spot area) field of view, and the image may be displayed to the driver of the vehicle to assist the driver in backing up or reversing or otherwise driving or maneuvering the vehicle. The use of electronic cameras in these applications significantly increases the driver's knowledge of the space immediately surrounding the vehicle, which may be of importance prior to and during low speed maneuvers, and thus contributes to the safe completion of such maneuvers.

It is thus known to provide a camera or imaging sensor on a vehicle for providing an image of a scene occurring exteriorly or interiorly of the vehicle to a driver of the vehicle. Such a camera may be positioned within a protective housing, which may be closed about the camera or sensor and secured together via fasteners or screws or the like. For example, a metallic protective housing may be provided, such as a die cast housing of aluminum or zinc or the like. In particular, for camera sensors mounted on the exterior of a vehicle, protection against environmental effects, such as rain, snow, road splash and/or the like, and physical protection, such as against road debris, dirt, dust, and/or the like, is important. Thus, for example, in known exterior camera sensor mounts, a butyl seal, such as a hot dispensed butyl seal, or an O-ring or other sealing member or material or the like, has been provided between the parts of the housing to assist in sealing the housing to prevent water or other contaminants from entering the housing and damaging the camera or sensor positioned therein. However, such housings typically do not provide a substantially water tight seal, and water droplets thus may enter the housing. Furthermore, any excessive vibration of the camera sensor, due to its placement (such as at the exterior of the vehicle), may lead to an undesirable instability of the image displayed to the driver of the vehicle. Also, such cameras or sensors are costly to manufacture and to implement on the vehicles.

### SUMMARY OF THE INVENTION

The present invention provides a camera module that has an outer shell molded over a circuit board and portion of a lens assembly. The circuit board is thus contained or encapsulated and sealed within the outer shell.

According to an aspect of the present invention, a camera module for a vision system of a vehicle includes a circuit board, a lens holder or lens mounting assembly for mounting a lens assembly, and an outer shell. The circuit board includes an imaging sensor and associated circuitry. The lens assembly includes at least one optical element and the lens mounting element is attached to the circuit board so as to provide an optical path through the at least one optical element to the imaging sensor at the circuit board. The outer shell is molded over and around the circuit board during a molding process to substantially encapsulate the circuit board within the outer shell.

Preferably, the outer shell is molded over the circuit board assembly via a low pressure molding process. The outer shell thus may substantially seal the circuit board and circuitry therewithin to provide enhanced protection of the circuitry against the environment at which the camera module may be positioned.

Optionally, the outer shell may be molded over the circuit board and a portion of the lens mounting element to seal the circuit board at the lens mounting element. Optionally, the circuit element may be mounted at least partially within the lens mounting element that supports the lens assembly, and the outer shell may be molded around the circuit element and at least partially within the lens mounting element to substantially encapsulate the circuit element within the lens mounting element. Optionally, the circuit element may include a wire harness extending therefrom, and the outer shell may be molded around a connector portion of the wire harness to substantially encapsulate the connector portion of the wire harness within the outer shell.

Therefore, the present invention provides a camera or imaging device or module that includes an imaging sensor and associated circuitry on a circuit element or circuit board or chip that is assembled to a lens assembly or to a lens mounting element or lens holder and that is substantially encased and sealed within a molded outer plastic or polymeric shell. By molding the outer shell around and over the circuit element and circuitry, the circuitry is substantially protected and sealed against water intrusion or other environmental elements and effects, and thus provides a substantially water impervious, robust camera module that may be highly suited for exterior vehicle applications. Also, by molding the outer shell over the circuit element, the outer shell (and the overall camera module) may be substantially smaller than known cameras that have the circuitry and sensor located within a hollow housing or casing.

These and other objects, advantages, purposes and features of the present invention will become apparent upon review of the following specification in conjunction with the drawings.

### BRIEF DESCRIPTION OF THE DRAWINGS

FIG. 1 is a perspective view of an imaging device in accordance with the present invention;

FIG. 2 is another perspective view of the imaging device of FIG. 1;

FIG. 3 is a partial sectional and perspective view of the imaging device of FIGS. 1 and 2;

FIG. 4 is a perspective view of another imaging device in accordance with the present invention;

FIG. 5 is a side elevation of the imaging device of FIG. 4;

FIG. 6 is an exploded perspective view of the imaging device of FIGS. 4 and 5;

FIG. 7 is an end view of the imaging device of FIGS. 4-6, as viewed along a portion of the cable;

FIG. 8 is a sectional view of the imaging device taken along the line VIII-VIII of FIG. 7;

FIG. 9 is a perspective view of the imaging device of FIGS. 4-8;

FIG. 10 is an end elevation of the imaging device, as viewed along the lens of the imaging device;

FIG. 11 is an end elevation of the imaging device, as viewed at the cable connection end of the imaging device and with the cable removed;

FIGS. 12-15 are perspective views of another imaging device in accordance with the present invention;

FIG. 16 is a sectional view of the imaging device taken along the line XVI-XVI in FIG. 15;

FIG. 17 is a sectional view of the imaging device taken along the line XVII-XVII in FIG. 15;

FIG. 18 is a perspective view of a housing portion of the imaging device of FIGS. 12-15;

FIG. 19 is another perspective view of the housing portion of FIG. 18;

FIG. 20 is a perspective view of a housing portion or cover of the imaging device of FIGS. 12-15; and

FIG. 21 is an opposite perspective view of the housing portion of FIG. 20.

### DESCRIPTION OF THE PREFERRED EMBODIMENTS

Referring now to the drawings and the illustrative embodiments depicted therein, a camera or imaging device or module 10 is adapted for use on or in or at a vehicle and is associated with at least one vision system of the vehicle. Camera module 10 includes a circuit board or chip or element 12 (on which an imaging sensor and associated circuitry is established), a lens assembly 14 and a molded encapsulant or overmold or outer shell 16. Lens assembly 14 is secured or attached to circuit board 12 such that the lens optic or optics 14a function to focus and direct and refract an image of the scene at the field of view of the lens optics onto the imaging sensor. Outer shell 16 is molded over and around the circuit board 12 and over a portion of the lens assembly 14 to substantially or entirely encase or encapsulate the circuit board 12 and circuitry within the molded outer shell 16, as discussed below.

The circuit board or element 12 of camera or imaging device module 10 includes a camera or image capture device or sensor for capturing an image of a scene occurring exteriorly or interiorly of a vehicle. Camera module 10 may utilize aspects of the camera described in U.S. patent application Ser. No. 10/534,632, filed May 11, 2005 by Bingle et al. for IMAGING SYSTEM FOR VEHICLE (Attorney Docket DON01 P-1118); and/or Ser. No. 11/201,661, filed Aug. 11, 2005 and published Feb. 23, 2006 as U.S. Publication No. US-2006-0038668-A1 (Attorney Docket DON01 P-1233), which are hereby incorporated herein by reference in their entireties. Optionally, the images captured by the imaging sensor may be communicated to a display or display system which is operable to display the images to a driver of the vehicle. The camera or imaging sensor useful with the present invention may comprise an imaging array sensor, such as a CMOS sensor or a CCD sensor or the like, such as disclosed in commonly assigned U.S. Pat. Nos. 5,550,677; 5,670,935; 5,796,094; and 6,097,023, and U.S. patent application Ser. No. 09/441,341, filed Nov. 16, 1999 by Schofield et al. for VEHICLE HEADLIGHT CONTROL USING IMAGING SENSOR (Attorney Docket DON01 P-770), which are hereby incorporated herein by reference in their entireties.

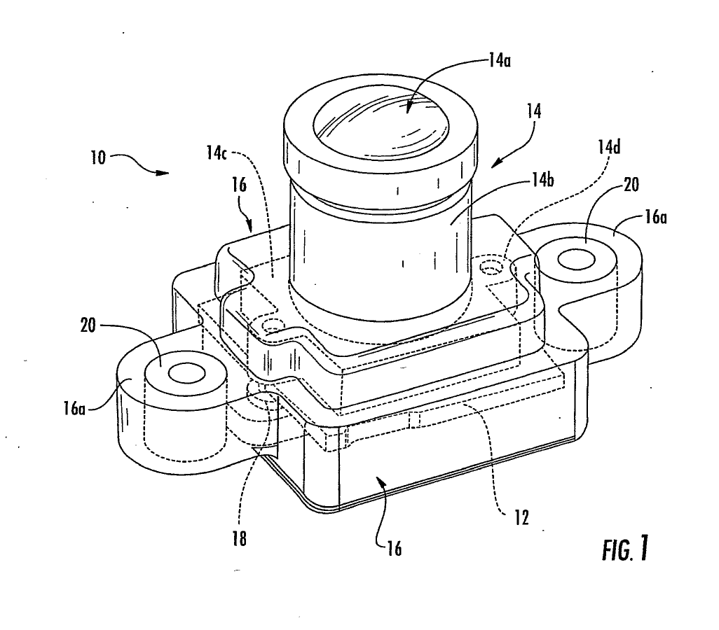

As can be seen with reference to FIGS. 1-3, outer shell 16 is molded over and around the circuit board 12 to substantially encase and encapsulate the circuit board 12 and associated circuitry 12a established thereon. Prior to molding the outer shell 16 over and around the circuit board 12 and circuitry 12a, the lens assembly 14 is attached to the circuit board 12 to form a lens and circuit board sub-assembly. As can be seen in FIG. 3, lens assembly 14 includes a lens holder or generally cylindrical housing 14b that may house the lens optics 14a therein to provide an optical path between an outer lens or optic 14a and the focal point or location of the lens (which is at the imaging sensor when the lens assembly is attached to the circuit board 12). The lens holder of lens assembly 14 also includes a mounting base or portion 14c at a base of the generally cylindrical housing 14b. As shown in FIG. 3, the mounting base 14c may include tabs 14d for receiving a fastener 18 for attaching the lens assembly 14 to the circuit board 12, as described below. The lens optic or optics 14a may be adjustably positioned at the housing 14b, such as via a threaded attachment or the like to facilitate adjustment of the focal point of the lens depending on the particular application of the lens assembly.

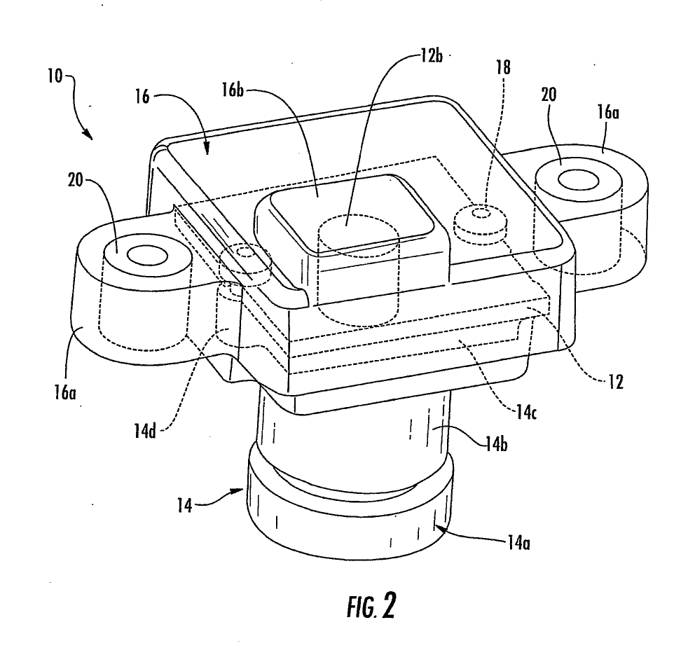

Mounting base 14c may be attached to circuit board 12 via a pair of fasteners 18 that extend through openings (which may be threaded openings) in tabs 14d and in circuit board 12 to secure the lens assembly 14 to circuit board 12 and to form a circuit board and lens sub-assembly. As can be seen in FIG. 2, circuit board 12 receives and attaches to lens assembly 14 so that the lens assembly protrudes outwardly from a surface of the circuit board (the surface at which the imaging sensor is established). Circuit board 12 also includes circuitry 12a, such as circuitry associated with the imaging sensor, with some of the circuitry being located at the opposite side or surface of the circuit board 12 and thus not encased or covered by the lens assembly.

Outer shell 16 is molded over and around the circuit board 12 and the lens holder, including the mounting base 14c and/or cylindrical housing 14b of lens assembly 14, to substantially or entirely encase/encapsulate the circuit board and circuitry within the housing or outer shell. The outer shell 16 may also be molded to have mounting tabs or portions 16a extending therefrom for attaching or mounting the camera module 10 to the vehicle. Optionally, the mounting tabs 16a may have strengthening elements or posts or bosses 20 or the like insert molded therein to provide structural strength and rigidity to the mounting tabs 16a. The outer shell may be molded to accommodate the circuitry on the circuit board 12, and the shape of the outer shell may be selected depending on the size and arrangement of the different circuit components at the circuit board. For example, and as shown in FIG. 3, the outer shell 16 may include a raised portion 16b protruding outwardly to provide sufficient housing material or wall thickness over and around one or more of the larger circuit components (such as the capacitor 12b in FIG. 2) at the circuit board 12.

Although not shown in FIGS. 1-3, camera module 10 may include a connector, such as a plug or socket type connector or the like, at its outer surface for connection to an electrical connector of the vehicle, so as to provide power and control and signal communication to and from the camera module. For example, the circuit board may include terminals, such as multiple pins or the like, extending outwardly therefrom, and the outer shell may be molded around the terminals so that the terminals are accessible from the outer surface of the outer shell, whereby the terminals may readily connect to a vehicle connector or wire or the like. The outer shell thus may be formed to leave at least a portion of the terminals exposed, such as at a recess in the surface of the outer shell, or the terminals may protrude outwardly from the surface of the outer shell, for electrical connection to the vehicle wire and connector.

Outer shell 16 may comprise any suitable material, such as a plastic or polymeric material, that may be overmolded around the lens and circuit board sub-assembly. Preferably, the outer shell material comprises a soft plastic material that may be molded at a low pressure to limit or substantially preclude damage to the circuitry at the circuit board during the molding process. For example, the outer shell material may comprise a low pressure molding hot melt resin, such as the resins commercially available from Bostik, Inc. of Middleton, Mass. or the like. Such resins include BOSTIK® LPM 245 adhesive, BOSTIK® LPM 915 adhesive, BOSTIK® LPM 917 adhesive and/or the like. However, other suitable resins or materials may be utilized, such as HENKEL®/LOCTITE® Macromelt materials, such as HENKEL® OM673, 678, 682 and/or 687 Macromelt and/or the like, while remaining within the spirit and scope of the present invention. Such low pressure molding resins provide a high performance thermoplastic that, once molded, provide a high degree of environmental protection including substantial resistance to many fluids, while also providing a substantially high melt point. Other moldable materials may be used for the outer shell without affecting the scope of the present invention.

Optionally, the outer shell may include ferrous material or elements (preferably non-conductive ferrous elements) within the plastic material, so that the overmolded outer shell may provide shielding properties for EMC and thus enhanced performance of the camera module. Optionally, a thin low pressure protective shell may be molded over the circuit board and circuitry and portion of the lens assembly, and an outer shell may be overmolded the thin protective shell to provide the desired thickness and outer strength of the shell and the desired protection of the circuit board and circuitry. For example, such inner and outer shells may be molded utilizing aspects described in U.S. patent application Ser. No. 10/256,707, filed Sep. 27, 2002 by March et al. for VEHICLE HANDLE ASSEMBLY WITH ANTENNA, now U.S. Pat. No. 6,977,619 (Attorney Docket DON01 P-1005), which is hereby incorporated herein by reference in its entirety.

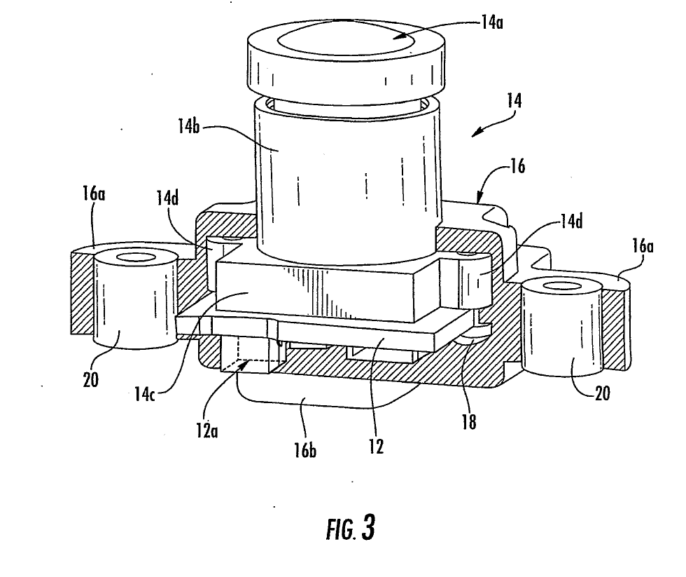

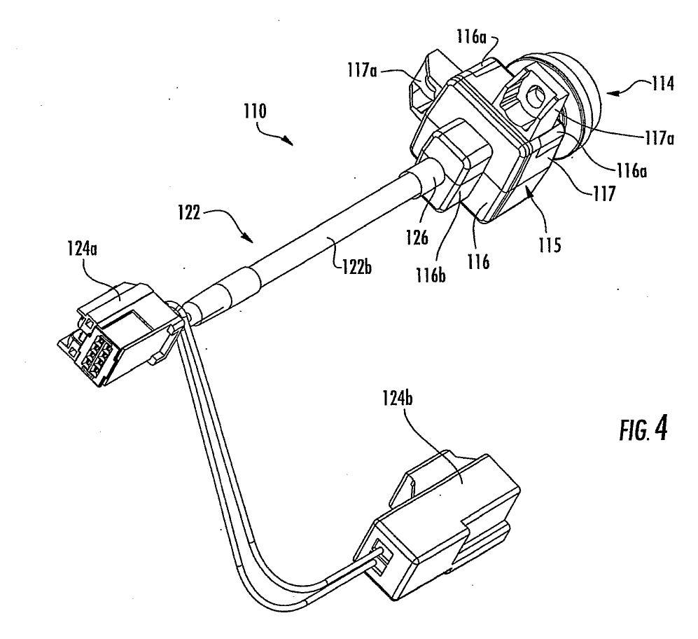

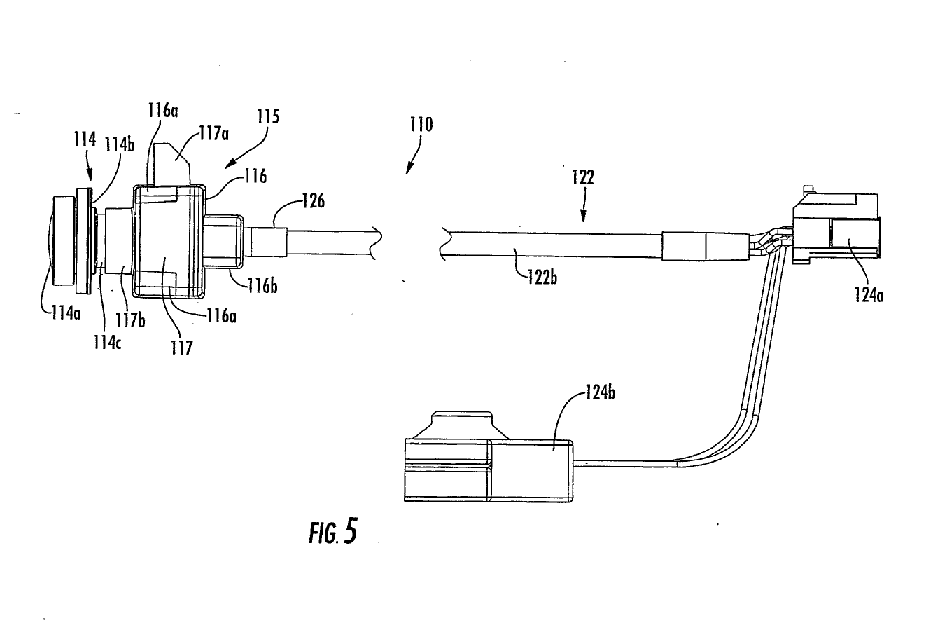

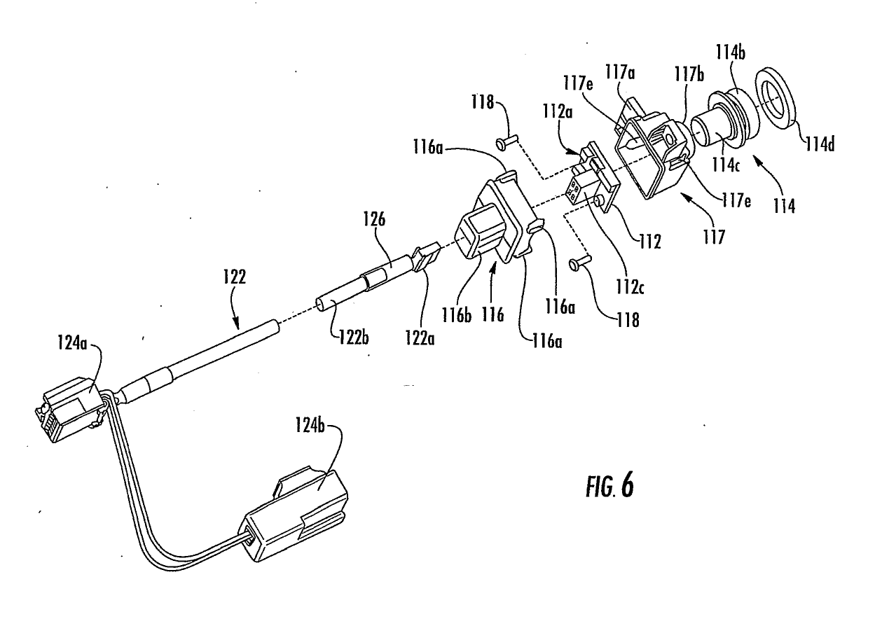

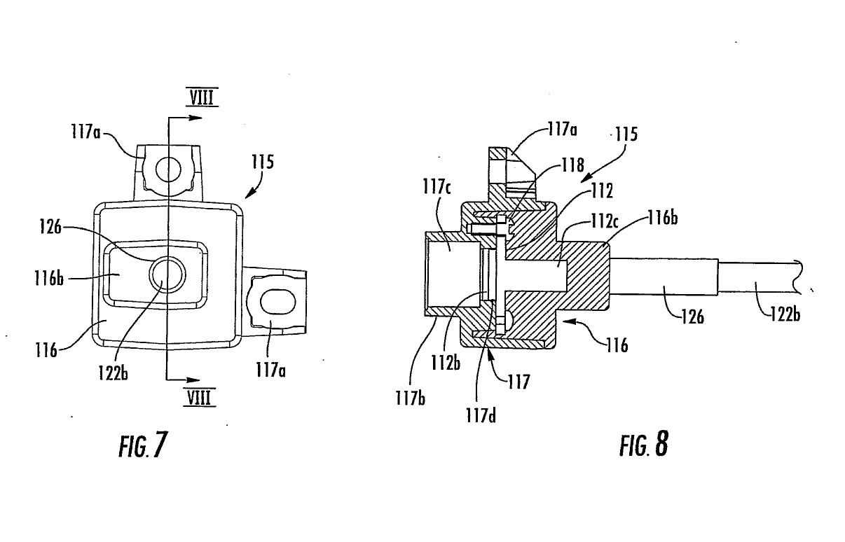

Optionally, and with reference to FIGS. 4-11, a camera or imaging device or module 110 is adapted for use on or in or at a vehicle and is associated with at least one vision system of the vehicle. Camera module 110 includes a circuit board or chip or element 112 (on which an imaging sensor 112b and associated circuitry 112a is established), a lens assembly 114 and a housing or casing 115, which includes a molded encapsulant or overmold or outer shell or portion 116 and a lens holder or lens mounting casing or housing or portion 117. As can be seen with reference to FIG. 6, circuit board 112 is mountable or attachable to lens mounting portion 117, and overmolded portion 116 is molded over and around the circuit board 112 and in the cavity of the lens mounting portion 117 so as to substantially or entirely encase or encapsulate the circuit board 112 and circuitry 112a within the overmolded portion 116 and lens mounting portion 117 of housing 115, as discussed below. Camera module 110 also includes a cable or wire harness 122 that is electrically connected to the circuitry of circuit board 112 and that includes an electrical connector or connectors 124a, 124b that is/are electrically connectable to circuitry or a wire harness of the vehicle or the like, so as to provide power and communication and control between the vehicle and the camera module.

Lens mounting portion 117 may comprise a molded plastic casing having one or more mounting elements or structures or tabs 117a for mounting or attaching the camera module 110 to the vehicle, such as at an exterior portion of the vehicle, such as a rearward exterior portion of the vehicle for capturing images of an area rearward of the vehicle, such as for a back up aid system or rear vision system or the like. Lens mounting portion 117 may comprise any suitable plastic or polymeric material, such as a durable engineered plastic or other suitable plastic material, without affecting the scope of the present invention.

Lens mounting portion 117 includes a lens receiving or mounting structure 117b that protrudes from a surface of lens mounting portion 117 and defines a passageway 117c for at least partially receiving the lens assembly and for providing an optical path through the lens assembly 114 and to the imaging sensor at the circuit board 112. Lens mounting portion 117 includes outer side walls that cooperate to define a cavity or pocket for receiving the circuit board 112 therein, and may include an imaging sensor receiving passageway 117d (FIG. 8) for receiving and/or aligning the imaging sensor 112b of circuit board 112 when the circuit board is mounted to the lens mounting portion 117, as discussed below. The outer side walls of the lens mounting portion 117 may have apertures 117e (FIG. 6) formed therethrough for receiving molded tabs 116a of molded shell 116 therein when the shell is molded to and in the lens mounting portion 117, as also discussed below.

Lens assembly 114 is attached to lens receiving structure 117b of lens mounting portion 117 so as to be generally aligned with the imaging sensor disposed at the circuit board 112 such that the lens optic or optics 114a function to focus and direct and refract an image of the scene at the field of view of the lens optics onto the imaging sensor 112b. Preferably, lens assembly 114 is threaded into a cylindrical lens receiving structure 117b to secure the lens to the lens mounting portion 117 and to substantially seal the lens assembly relative to the lens mounting portion. In the illustrated embodiment, lens assembly 114 includes a generally cylindrical housing 114b that may house the lens optics 114a therein to provide an optical path between an outer lens or optic 114a and the focal point or location of the lens (which is at the imaging sensor when the lens assembly is attached to the lens receiving structure 117b and the circuit board 112 is attached to lens mounting portion 117). The lens optic or optics 114a may be adjustably positioned at the lens receiving structure 117b, such as via a threaded attachment or the like to facilitate adjustment of the focal point of the lens depending on the particular application of the lens assembly. As shown in FIG. 6, lens assembly 114 includes a mounting portion 114c for threading into lens receiving structure 117b, and includes an outer gasket or seal 114d for sealing or substantially sealing the lens at the vehicle when mounted thereto.

Optionally, and desirably, an adhesive or sealant or bonding agent may be applied at the threaded joint to substantially seal the lens assembly at the lens mounting element. The adhesive or sealant or bonding agent may comprise any suitable material, such as, for example, an anaerobic material (such as for applications where the mounting portion 114c and the lens receiving structure 117b both comprise metallic materials), such as, for example, a LOCTITE® 2440 anaerobic adhesive, or, for example, an aerobic adhesive or other suitable adhesive (such as if one or both of the mounting portion 114c and lens mounting portion 117b comprise a plastic or polymeric material, such as if the mounting portion 114c comprises a plastic or metallic material and the lens mounting portion 117b comprises a metallic or plastic material), such as, for example, a LOCTITE® Hysol epoxy or the like, while remaining within the spirit and scope of the present invention.

In the illustrated embodiment, and as can be seen with reference to FIGS. 6 and 8, circuit board 112 is secured or attached or mounted to lens mounting portion 117 via a pair of fasteners 118 that extend through openings in or through circuit board 112 and into openings (such as threaded openings) at or in lens mounting portion 117 to form a circuit board sub-assembly. Circuit board 112 includes circuitry 112a, such as circuitry associated with the imaging sensor 112b. When mounted to the lens mounting portion 117, circuit board 112 is received within the cavity or pocket defined by the outer walls of the lens mounting portion 117, with some of the circuitry being located at the opposite side or surface of the circuit board 112 from the lens receiving structure 117b of lens mounting portion 117. The passageway 117d of lens mounting portion 117 assists in aligning or locating the imaging sensor 112b so as to be aligned with the lens optics of the lens 114 that is received in the lens receiving structure 117b, such that the images focused by lens 114 are focused onto the imaging plane of the imaging sensor 112b. The circuit board, when mounted at the lens mounting portion 117, may be pressed or sealed against the inner surface of the lens mounting portion so that the imaging sensor 112b is substantially sealed within the passageway 117d, such that the overmolding material of overmolded portion 116 does not intrude into the passageway 117d during the overmolding process discussed below.

Overmolded portion 116 is molded to the circuit board sub-assembly (comprising lens mounting portion 117 and circuit board 112) to substantially encase and encapsulate and seal the circuit board and associate circuitry within the housing or casing 115. As can be seen with reference to FIGS. 6 and 8, overmolded portion 116 is molded over and around the circuit board 112 and within the cavity or pocket of lens mounting portion 117. The overmolded portion 116 thus fills or substantially fills the pocket of the lens mounting portion 117 to attach the overmolded portion to the lens mounting portion and to seal or substantially seal the circuit board and circuitry therein. Optionally, the overmolded portion may be formed to have one or more mounting tabs (such as mounting tabs similar to mounting tabs 117a of lens receiving portion 117) for mounting the camera module for the vehicle, while remaining within the spirit and scope of the present invention.

The overmolded portion may be molded and formed or shaped to accommodate the circuitry on the circuit board 112, and the shape of the overmolded portion may be selected depending on the size and arrangement of the different circuit components at the circuit board. For example, the overmolded portion 116 may include a raised portion 116b protruding outwardly to provide sufficient housing material or wall thickness over and around one or more of the larger circuit components, such as the electrical connector 112c at and extending from the circuit board 112. The overmolded portion may be molded over the electrical connector 112c, with the terminal end of the connector being exposed at an aperture or opening at the outer end of the overmolded portion, or the camera module wire harness 122 may be electrically connected to the electrical connector 112c prior to overmolding the outer shell or overmolded portion so that the wire harness connection is substantially sealed and encapsulated within the overmolded portion, as discussed below.

Overmolded portion 116 may comprise any suitable material, such as a plastic or polymeric material, that may be overmolded around the lens and circuit board sub-assembly. Preferably, and similar to outer shell 16 discussed above, the overmolded portion material comprises a soft plastic material that may be molded at a low pressure to limit or substantially preclude damage to the circuitry at the circuit board during the molding process. For example, the overmolded portion material may comprise a low pressure molding hot melt resin, such as the resins commercially available from Bostik, Inc. of Middleton, Mass. or the like. Such resins include BOSTIK® LPM 245 adhesive, BOSTIK® LPM 915 adhesive, BOSTIK® LPM 917 adhesive and/or the like. However, other suitable resins or materials may be utilized, such as HENKEL®/LOCTITE® Macromelt materials, such as HENKEL® OM673, 678, 682 and/or 687 Macromelt and/or the like, while remaining within the spirit and scope of the present invention. Such low pressure molding resins provide a high performance thermoplastic that, once molded, provide a high degree of environmental protection including substantial resistance to many fluids, while also providing a substantially high melt point. Other moldable materials may be used for the overmolded portion without affecting the scope of the present invention. Optionally, the overmolded portion and/or the lens mounting portion may include ferrous material or elements (preferably non-conductive ferrous elements) within the plastic material, so that the overmolded portion and/or lens mounting portion may provide shielding properties for EMC and thus enhanced performance of the camera module, such as described above.

Preferably, the overmolded portion is molded to or at or in the lens mounting portion in a manner that mechanically secures the overmolded portion to the lens mounting portion or casing. For example, and as can be seen with reference to FIGS. 4-6 and 9, overmolded portion 116 is molded so that tabs or protrusions 116a of overmolded portion 116 are molded into and at least partially through openings or apertures 117e of lens mounting portion 117, whereby the tabs 116a mechanically secure the overmolded portion 116 to the lens mounting portion 117 after the overmolded portion is molded thereto. For example, the circuit board sub-assembly may be placed in a mold with the mold cavity receiving the lens mounting portion 117 therein and providing a mold cavity wall at the outer surface of the lens mounting portion and along the outer surface even at the areas where the openings or apertures are formed through the walls of the lens mounting portion. Thus, when the overmolded portion is molded into the lens mounting portion, the molding material flows through the apertures in the lens mounting portion and the overmolded portion is formed with the tabs that extend through the apertures and are generally flush with the outer surface of the lens mounting portion. Other means for securing or mechanically securing the overmolded portion with the lens mounting portion may be implemented while remaining within the spirit and scope of the present invention.

Preferably, the materials for the lens mounting portion 117 and overmolded portion 116 are selected so that the materials may bond or adhere together as the overmolded portion is molded and cured at and partially within the lens mounting portion. For example, the softer material of the overmolded portion may bond to the harder material of the lens mounting portion to further secure the overmolded portion to the lens mounting portion and thus substantially seal and encapsulate the circuit board within the housing 114.

In the illustrated embodiment, camera module 110 includes wire harness 122, which includes an electrical connector 122a (FIG. 6), such as a plug or socket type connector or the like, at an end of the wires or cable 122b for electrically connecting the wire harness to the connector 112c of circuit board 112. The connector 122a may connect to (such as via plugging into) the connector 112c to electrically connect the wire harness to the circuitry of camera module 110, whereby the connector or connectors 124a, 124b at the opposite end of wire harness 122 may electrically connect to an electrical connector of the vehicle, so as to provide power and control and signal communication to and from the camera module. Optionally, the connector 122a of wire harness 122 may be connected to the connector 112c of circuit board 112 prior to overmolding of the overmolded portion 116, such that the overmolded portion 116 may be overmolded over the connector 112c and at least partially over the connector 122a and/or wires 122b to substantially seal the connection of the wire harness and module. Such a sealed or overmolded connection may provide a means for retaining the connection without a need for a locking feature at the connectors, and may reduce the strain or provide strain relief for the wire harness at the connection to the camera module. Optionally, the camera module 110 may include a wire sleeve 126 that may be positioned at the connector end of the wire harness to encapsulate or encase the wire harness whereby the overmolded portion encapsulates the wire sleeve at the connector end of the wire harness. The overmolded portion thus substantially encases or encapsulates the electrical connection between the wire harness and the circuit board and may retain the connection and may reduce the strain at the connection of the wire harness to the circuit board of the camera module.

Thus, the lens mounting portion may be provided and the circuit board or circuit element may be attached thereto and partially therein, with the imaging sensor or camera received within and located at an alignment/locating portion or passageway of the lens mounting portion. The connector 122a of wire harness 122 may be connected to the connector 112c of the circuit board 112, such that the circuit board, wire harness and lens mounting portion sub assembly may be placed in or at the mold cavity for overmolding the overmolded portion at and around the circuit board. The overmolding material may be molded (such as via injection molding) around the circuit board and circuitry and within the cavity of the lens mounting portion and around the connectors 122a, 112c to substantially seal and encapsulate the circuit board and connectors within the overmolded portion. Thus, and although shown in FIG. 6 as comprising separate elements or components, the overmolded portion 116 would not be formed until after the circuit board is attached to the lens mounting portion and after the wire harness is connected to the circuit board, whereby the overmolded portion is molded over the circuit board and connectors to substantially secure and seal and encapsulate the circuitry and electrical connectors within the camera module.

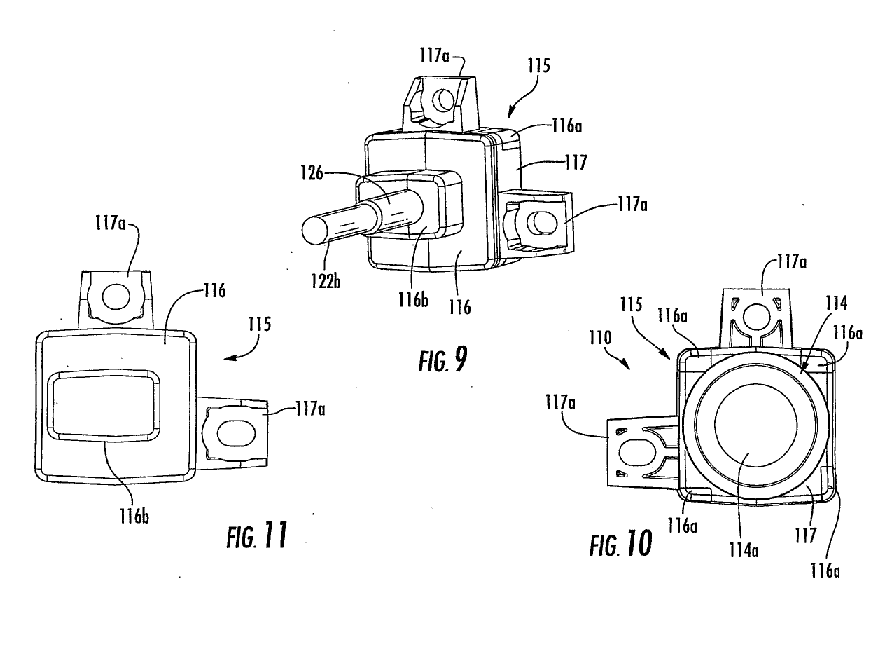

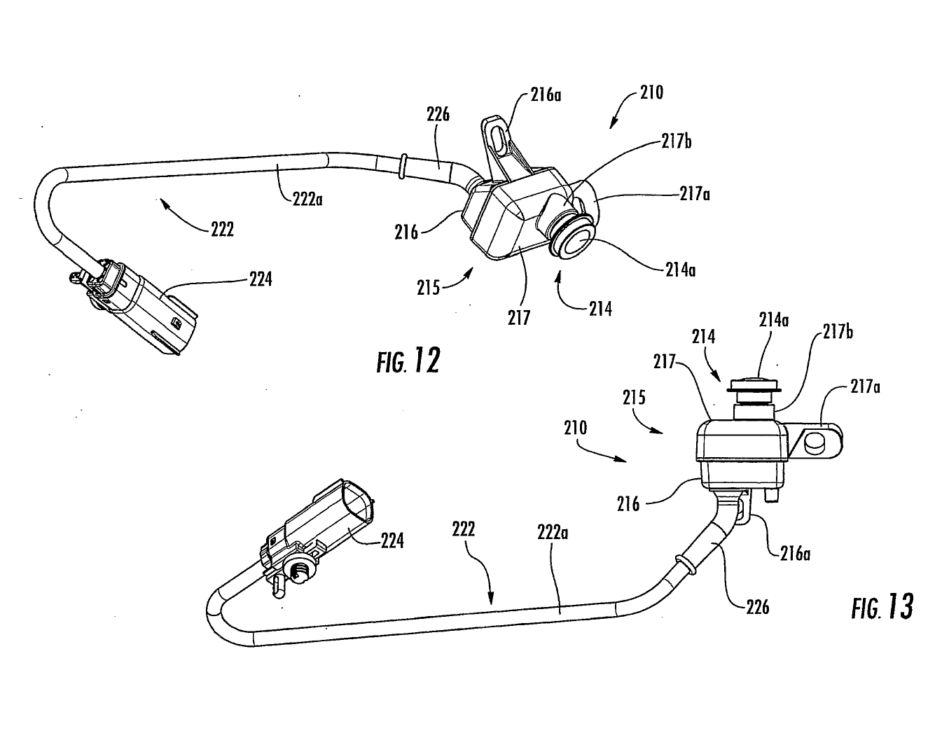

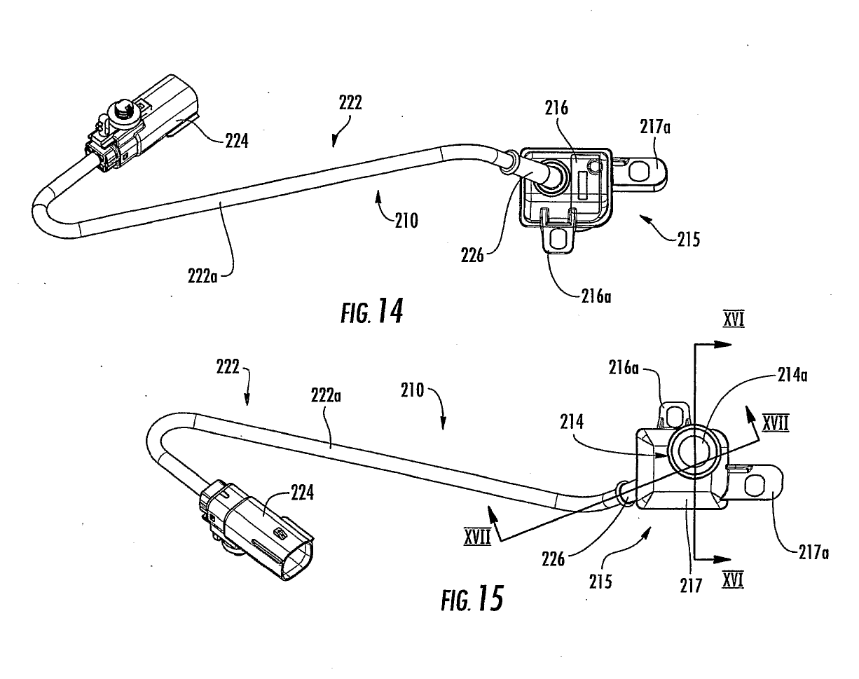

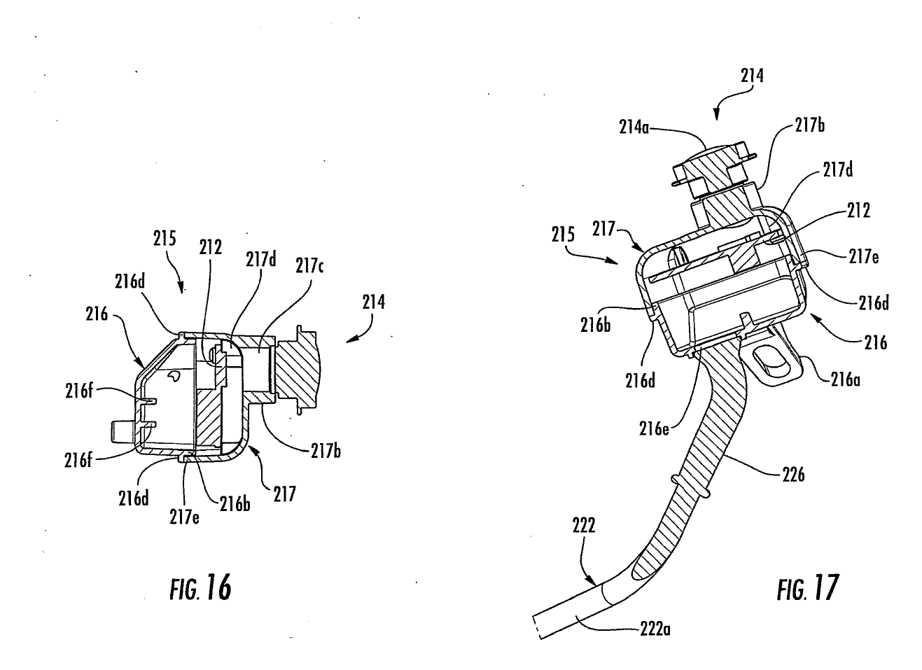

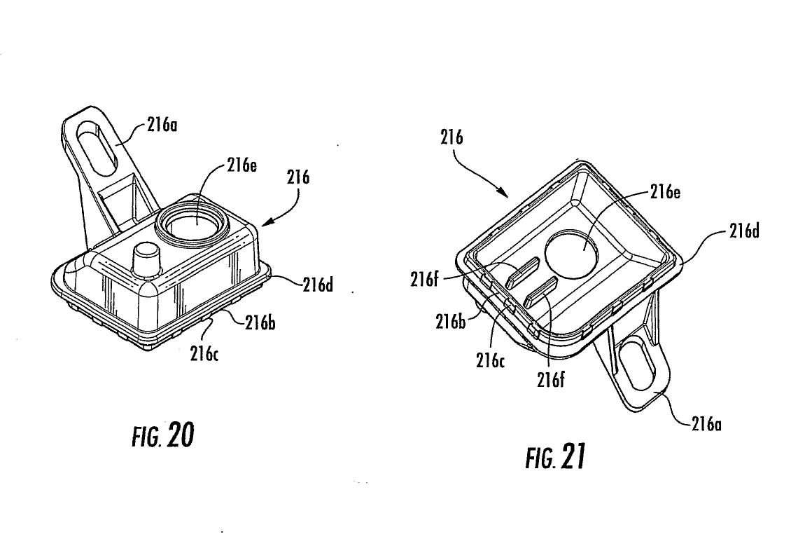

Optionally, and with reference to FIGS. 12-21, a camera or imaging device or module 210 is adapted for use on or in or at a vehicle and is associated with at least one vision system of the vehicle. Camera module 210 includes a circuit board or chip or element 212 (on which an imaging sensor and associated circuitry is established), a lens assembly 214 and a housing or casing 215, which includes a back cover portion 216 and a lens holder or lens mounting casing or housing or portion 217. As can be seen with reference to FIGS. 16 and 17, circuit board 212 is mountable or attachable to lens mounting portion 217 (such as via threaded fasteners or the like), and cover portion 216 is secured to and sealed or substantially sealed with lens mounting portion 217 so as to substantially or entirely encase or encapsulate the circuit board 212 and circuitry within the housing or casing 215, as discussed below. Camera module 210 also includes a cable or wire harness 222 that is electrically connected to the circuitry of circuit board 212 and that includes an electrical connector 224 that is electrically connectable to circuitry or a wire harness of the vehicle or the like, so as to provide power and communication and control between the vehicle and the camera module.

Lens mounting portion 217 may include one or more mounting elements or structures or tabs 217a for mounting or attaching the camera module 210 to the vehicle, such as at an exterior portion of the vehicle, such as a rearward exterior portion of the vehicle for capturing images of an area rearward of the vehicle, such as for a back up aid system or rear vision system or the like. Lens mounting portion 217 may comprise any suitable material, such as any suitable metallic material, such as a metallic material or the like, such as a zinc alloy material or the like, such as, for example, a die cast ZAMAK® 3 material (a zinc alloy commercially available from New Jersey Zinc Company of Newark, N.J., and typically having about 4 percent aluminum and about 0.035 percent magnesium) or other suitable metallic material. Likewise, cover portion 216 may include one or more mounting elements or structures 216a for mounting or attaching the camera module 210 to the vehicle, such as at an exterior portion of the vehicle. Also, cover portion 216 may comprise any suitable material, such as any suitable metallic material, such as a metallic material or the like, such as a die cast zinc alloy, such as, for example, a die cast ZAMAK® 3 material or other suitable metallic material.

Lens mounting portion 217 includes a lens receiving or mounting structure 217b that protrudes from a surface of lens mounting portion 217 and defines a passageway 217c (FIG. 16) for at least partially receiving the lens assembly 214 and for providing an optical path through the lens assembly 214 and to the imaging sensor at the circuit board 212. Lens mounting portion 217 includes outer side walls that cooperate to define a cavity or pocket for receiving the circuit board 212 therein, and may include an imaging sensor receiving passageway for receiving and/or aligning the imaging sensor of the circuit board, such as in a similar manner as discussed above. The lens mounting portion may include threaded apertures or bosses 217d for attaching the circuit board to the inner portion of the lens mounting portion, such as via threaded fasteners or the like.

Lens assembly 214 is attached to lens receiving structure 217b of lens mounting portion 217 so as to be generally aligned with the imaging sensor disposed at the circuit board 212 such that the lens optic or optics 214a function to focus and direct and refract an image of the scene at the field of view of the lens optics onto the imaging sensor. Preferably, lens assembly 214 is threaded into a cylindrical lens receiving structure 217b to secure the lens to the lens mounting portion 217 and to substantially seal the lens assembly relative to the lens mounting portion. In the illustrated embodiment, lens assembly 214 includes a generally cylindrical housing that may house the lens optics 214a therein to provide an optical path between an outer lens or optic 214a and the focal point or location of the lens (which is at the imaging sensor when the lens assembly is attached to the lens receiving structure 217b and the circuit board 212 is attached to lens mounting portion 217). The lens optic or optics 214a may be adjustably positioned at the lens receiving structure 217b, such as via a threaded attachment or the like to facilitate adjustment of the focal point of the lens depending on the particular application of the lens assembly.

Optionally, and desirably, an adhesive or sealant or bonding agent may be applied at the threaded joint to substantially seal the lens assembly at the lens mounting element. The adhesive or sealant or bonding agent may comprise any suitable material, such as, for example, an anaerobic material (such as for applications where the mounting portion of the lens assembly and the lens receiving structure 217b both comprise metallic materials), such as, for example, a LOCTITE® 2440 anaerobic adhesive, or, for example, an aerobic adhesive or other suitable adhesive (such as if one or both of the mounting portion of the lens assembly and the lens mounting portion 217b comprise a plastic or polymeric material, such as if the mounting portion of the lens assembly comprises a plastic or metallic material and the lens mounting portion 217b comprises a metallic or plastic material), such as, for example, a LOCTITE® Hysol epoxy or the like, while remaining within the spirit and scope of the present invention.

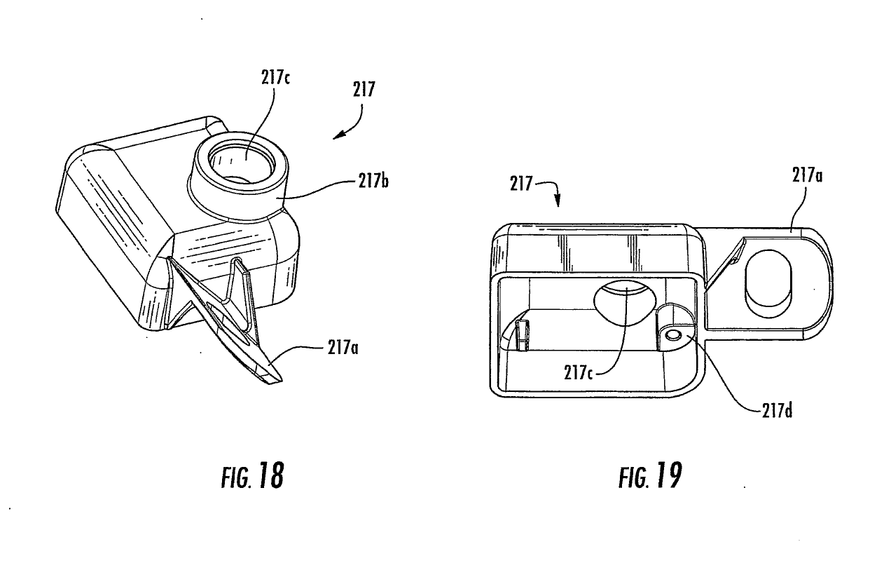

Cover portion 216 is configured with an engaging lip or edge 216b that engages a corresponding engaging lip or edge 217e of lens mounting portion 217, as can be seen with reference to FIGS. 16 and 17. A bead of adhesive or sealant may be applied around the edges so that when the cover portion is pressed against the lens mounting portion, the housing or casing is substantially sealed around its adjoining portions so as to limit or substantially preclude water intrusion into the housing. The selected adhesive or sealant may comprise any suitable adhesive or bonding agent, such as an anaerobic adhesive (such as if the cover portion and lens mounting portion are metallic components), such as, for example, a LOCTITE® 638 anaerobic adhesive. Optionally, the adhesive may comprise an aerobic adhesive or other suitable adhesive, while remaining within the spirit and scope of the present invention. Optionally, the cover portion may be sealed to or bonded or joined with the lens mounting portion via other suitable attachment/sealing means, such as via laser welding or sonic welding or the like (such as by utilizing aspects of the camera modules described in U.S. patent application Ser. No. 10/534,632, filed May 11, 2005 by Bingle et al. for IMAGING SYSTEM FOR VEHICLE (Attorney Docket DON01 P-1118), which is hereby incorporated herein by reference in its entirety), while remaining within the spirit and scope of the present invention. Optionally, and desirably, and as shown in FIGS. 18 and 19, cover portion 216 may include raised portions or protrusions 216c around the edge 216b, whereby the protrusions 216c engage the lip or edge 217e of lens mounting portion 217 and provide the desired or appropriate spacing or offset between the edge or lip 216b and the edge or lip 217e.

Thus, the housing may provide the desired or appropriate spacing or gap between the portions for enhancing the bond that is established by the adhesive or sealant or bonding agent disposed along the edges or lips and thus within the gaps between the edges or lips when the cover portion is attached to the lens mounting portion. In the illustrated embodiment, the edge or lip 216b of cover portion 216 is received within the edge or lip 217e of lens mounting portion 217, and the cover portion 216 includes a stop lip or flange 216d that limits insertion of the edge 216b into the lens mounting portion 217, such that the cover portion and lens mounting portion are properly joined and bonded together. Optionally, the sealed housing 215 may include a desiccant material or element therein to dry the interior cavity of the housing and/or to absorb any moisture that may enter the housing, such as during the process of joining the cover portion to the lens mounting portion.

In the illustrated embodiment, camera module 210 includes wire harness 222, which includes an electrical connector 224, such as a plug or socket type connector or the like, at an end of the wires or cable 222a for electrically connecting the wire harness to a vehicle connector or vehicle wire harness or the like. The camera module end of the wire harness 222 may connect to (such as via plugging into or soldering to) the circuitry at the circuit board 212 to electrically connect the wire harness to the circuitry of camera module 210, whereby the connector 224 may electrically connect to an electrical connector of the vehicle, so as to provide power and control and signal communication to and from the camera module.

Optionally, the wire harness 222 may include a grommet 226 that is attachable to and sealable at the cover portion 216 of housing 215 of camera module 210. For example, and as shown in FIG. 17, the grommet 226 may be inserted through an opening or aperture 216e at the rear wall of the cover portion 216 and may comprise a flexible or pliant material so as to substantially seal against the cover portion to limit or substantially preclude water intrusion into the housing 215 via the opening or aperture 216e. Optionally, the grommet 226 may be non-rotatably received through the aperture 216e and may be retained at the desired or appropriate or selected orientation via a tab at the inner end of grommet 226 (the end that is within the housing when the grommet is received through the aperture in the cover portion) engaging one or more protrusions 216f (FIGS. 16 and 19) at the inner wall or surface of the cover portion 216.

Thus, the lens mounting portion may be provided and the circuit board or circuit element may be attached thereto and partially therein, with the imaging sensor or camera received within and located at an alignment/locating portion or passageway of the lens mounting portion. The cover portion (with the wire harness and grommet attached thereto) may be provided at the lens mounting portion, and the wire harness may be connected to the circuit board (such as via a plug and socket connection or via soldering or otherwise connecting terminals of the wire harness to the circuit board). The cover portion may then be pressed against the lens mounting portion to secure the housing together. Preferably, a bead of adhesive or other suitable sealant or bonding material may be applied to the lip or edge of the lens mounting portion and/or cover portion to seal and bond the portions together when the housing is assembled.

Therefore, the camera module of the present invention provides an imaging sensor and associated circuitry on a circuit board or chip that is assembled to a lens assembly and is substantially encased and sealed within a molded outer shell. By molding the outer shell around and over the circuit board and circuitry, the circuitry is substantially protected and sealed against intrusion, such as water or vapor intrusion or the like, and thus provides a substantially water impervious, robust camera module that may be highly suited for exterior vehicle applications. The camera module of the present invention thus provides enhanced protection against environmental effects, such as rain, snow, road splash and/or the like, and, due to the strength of the outer shell material, provides physical protection, such as against road debris, dirt, dust, and/or the like. Also, by molding the outer shell over the circuit board, the outer shell (and the overall camera module) may be substantially smaller than known cameras that have the circuitry and sensor located within a hollow housing or casing. In the illustrated embodiment, the outer shell may be only about 2 mm larger or wider than the circuit board contained therein, thus providing a substantial size reduction over known cameras. Also, by overmolding the shell at and around and over the circuit board, the present invention may retain the printed circuit board (PCB) connector without a need for a locking feature, since the overmold material may provide this feature while also providing strain relief for the wire harness. Optionally, by sealing and adhering the cover portion to the lens mounting portion of the housing, the housing may be substantially sealed together when assembled, so as to limit or substantially preclude water (or other contaminants) intrusion into the housing.

Optionally, it is envisioned that other structures or elements may be integrally molded at the outer shell or cover portion during the overmolding process of the present invention. For example, other parts of the camera assembly or module, such as a small flange or brackets (such as for mounting the camera module at the vehicle or for connecting other elements such as a wire harness or the like at the camera module) or the like, can be molded or integrally formed or attached to the overmolded portion of the camera module. Optionally, conductors and/or bus bars or electrical terminals or conductors may be provided at the overmolded portion and may be insert molded therein during the overmolding process (such as for providing one or more electrical contacts at or in the overmolded portion of the camera module). Thus, the overmolding process of the present invention may provide other integral parts or elements of the camera module during the same molding process that forms the outer shell or cover portion and that encapsulates and/or seals the circuit element or circuit board and/or circuitry within the camera module.

The camera module and circuit chip or board and imaging sensor of the present invention may be implemented and operated in connection with various vehicular vision systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; and 6,831,261, and U.S. patent application Ser. No. 09/441,341, filed Nov. 16, 1999 by Schofield et al. for VEHICLE HEADLIGHT CONTROL USING IMAGING SENSOR (Attorney Docket DON01 P-770); Ser. No. 11/105,757, filed Apr. 14, 2005 by Schofield et al. for IMAGING SYSTEM FOR VEHICLE (Attorney Docket DON01 P-1208); and/or Ser. No. 10/421,281, filed Apr. 23, 2003 by Schofield for AUTOMATIC HEADLAMP CONTROL, now U.S. Pat. No. 7,004,606 (Attorney Docket DON01 P-1073), which are all hereby incorporated herein by reference in their entireties, a rain sensor, such as the types disclosed in commonly assigned U.S. Pat. Nos. 6,353,392; 6,313,454; and/or 6,320,176, and/or U.S. patent application Ser. No. 11/201,661, filed Aug. 11, 2005 and published Feb. 23, 2006 as U.S. Publication No. US-2006-0038668-A1 (Attorney Docket DON01 P-1233), which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; and 6,891,563, and/or in U.S. patent application Ser. No. 10/643,602, filed Aug. 19, 2003 by Schofield et al. for VISION SYSTEM FOR A VEHICLE INCLUDING IMAGING PROCESSOR (Attorney Docket DON01 P-1087); and/or Ser. No. 10/422,378, filed Apr. 24, 2003 by Schofield for IMAGING SYSTEM FOR VEHICLE, now U.S. Pat. No. 6,946,978 (Attorney Docket DON01 P-1074), which are all hereby incorporated herein by reference in their entireties, a trailer hitching aid or tow check system, such as the type disclosed in U.S. patent application Ser. No. 10/418,486, filed Apr. 18, 2003 by McMahon et al. for VEHICLE IMAGING SYSTEM, now U.S. Pat. No. 7,005,974 (Attorney Docket DON01 P-1070), which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 5,929,786 and/or 5,786,772, and/or U.S. patent application Ser. No. 10/427,051, filed Apr. 30, 2003 by Pawlicki et al. for OBJECT DETECTION SYSTEM FOR VEHICLE, now U.S. Pat. No. 7,038,577 (Attorney Docket DON01 P-1075); Ser. No. 11/239,980, filed Sep. 30, 2005 (Attorney Docket DON01 P-1238); and/or Ser. No. 11/315,675, filed Dec. 22, 2005 (Attorney Docket DON01 P-1253), and/or U.S. provisional applications, Ser. No. 60/628,709, filed Nov. 17, 2004 by Camilleri et al. for IMAGING AND DISPLAY SYSTEM FOR VEHICLE (Attorney Docket DON01 P-1188); Ser. No. 60/614,644, filed Sep. 30, 2004 (Attorney Docket DON01 P-1177); Ser. No. 60/618,686, filed Oct. 14, 2004 by Laubinger for VEHICLE IMAGING SYSTEM (Attorney Docket DON01 P-1183); Ser. No. 60/638,687, filed Dec. 23, 2004 by Higgins-Luthnian for OBJECT DETECTION SYSTEM FOR VEHICLE (Attorney Docket DON01 P-1195), which are hereby incorporated herein by reference in their entireties, a video device for internal cabin surveillance and/or video telephone function, such as disclosed in U.S. Pat. Nos. 5,760,962; 5,877,897; and/or 6,690,268; and/or PCT Application No. PCT/US03/40611, filed Dec. 19, 2003 by Donnelly Corp. et al. for ACCESSORY SYSTEM FOR VEHICLE (Attorney Docket DON01 FP-1123(PCT)), and/or U.S. patent applications, Ser. No. 11/284,543, filed Nov. 22, 2005 and published Jul. 27, 2006 as U.S. Publication No. US-2006-164230-A1 (Attorney Docket DON01 P-1245); and/or Ser. No. 10/538,724, filed Jun. 13, 2005 and published Mar. 9, 2006 as U.S. Publication No. US-2006-0050018-A1 (Attorney Docket DON01 P-1123), and/or U.S. provisional applications, Ser. No. 60/630,061, filed Nov. 22, 2004 by Lynam et al. for MIRROR ASSEMBLY WITH VIDEO DISPLAY (Attorney Docket DON01 P-1189); and Ser. No. 60/667,048, filed Mar. 31, 2005 by Lynam et al. for MIRROR ASSEMBLY WITH VIDEO DISPLAY (Attorney Docket DON01 P-1212), which are hereby incorporated herein by reference in their entireties, a traffic sign recognition system, a system for determining a distance to a leading or trailing vehicle or object, such as a system utilizing the principles disclosed in U.S. Pat. No. 6,396,397 and/or U.S. patent application Ser. No. 10/422,512, filed Apr. 24, 2003 by Schofield for DRIVING SEPARATION DISTANCE INDICATOR (Attorney Docket DON01 P-1072), which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. patent application Ser. No. 11/021,065, filed Dec. 23, 2004 by McCabe et al. for ELECTRO-OPTIC MIRROR CELL (Attorney Docket DON01 P-1193); Ser. No. 11/201,661, filed Aug. 11, 2005 by DeWard et al. for ACCESSORY MODULE FOR VEHICLE (Attorney Docket DON01 P-1233); and/or Ser. No. 11/226,628, filed Sep. 14, 2005 by Karner et al. (Attorney Docket DON01 P-1236), which are hereby incorporated herein by reference in their entireties.

Optionally, the camera or imaging device may be positioned at an interior rearview mirror assembly of the vehicle, and may be located in the mirror assembly and directed generally forwardly or rearwardly with respect to the direction of travel of the vehicle for providing an exterior field of view in the forward or rearward direction. Optionally, the camera or imaging device may be directed toward one or more locations within the vehicle cabin to provide an interior field of view, such as for a cabin monitoring system or the like.

Changes and modification in the specifically described embodiments may be carried out without departing from the principles of the present invention, which is intended to be limited only by the scope of the appended claims as interpreted according to the principles of patent law.

1. A camera module for a vision system of a vehicle, said camera module comprising:
a circuit element, said circuit element including an imaging sensor and associated circuitry;
a lens mounting element for holding a lens assembly, said lens assembly including at least one optical element, said lens mounting element being attached to said circuit element so as to provide an optical path through said at least one optical element of said lens assembly to said imaging sensor at said circuit element; and
an outer shell, said outer shell being molded over and around said circuit element during a molding process to substantially encapsulate said circuit element within said outer shell.

2. The camera module of claim 1, wherein said outer shell is molded over said circuit element via a low pressure molding process.

3. The camera module of claim 2, wherein said outer shell substantially seals said circuit element therewithin to provide enhanced protection of said associated circuitry against the environment at which said camera module is positioned.

4. The camera module of claim 1, wherein said outer shell is molded around said circuit element and a portion of said lens mounting element during said molding process.

5. The camera module of claim 1, wherein said outer shell is molded over said circuit element and at least partially into said lens mounting element.

6. The camera module of claim 5, wherein said outer shell is molded into said lens mounting element so as to mechanically secure said outer shell to said lens mounting element.

7. The camera module of claim 1, wherein said circuit element is mounted at least partially within said lens mounting element that supports said lens assembly, said outer shell being molded around said circuit element and at least partially within said lens mounting element to substantially encapsulate said circuit element within said lens mounting element.

8. The camera module of claim 7, wherein said circuit element includes a wire harness extending therefrom, said outer shell being molded around a connector portion of said wire harness to substantially encapsulate said connector portion of said wire harness within said outer shell.

9. The camera module of claim 1, wherein said circuit element includes a wire harness extending therefrom, said outer shell being molded around a connector portion of said wire harness to substantially encapsulate said connector portion of said wire harness within said outer shell.

10. A method of forming a camera module for a vision system of a vehicle, said method comprising:
providing a circuit element, said circuit element including an imaging sensor and associated circuitry;
providing a lens mounting element for mounting a lens assembly, said lens assembly including at least one optical element, said lens mounting element being attached to said circuit element so as to provide an optical path through said at least one optical element of said lens assembly to said imaging sensor at said circuit element; and
molding an outer shell over and around said circuit element via a molding process to substantially encapsulate said circuit element within said outer shell.

11. The method of claim 10, wherein molding an outer shell comprises molding an outer shell via a low pressure molding process.

12. The method of claim 10, wherein molding an outer shell comprises molding an outer shell that substantially seals said circuit element therewithin to provide enhanced protection of said associated circuitry against the environment at which said camera module is positioned.

14. The method of claim 10, wherein molding an outer shell over and around said circuit element comprises molding an outer shell over and around said circuit element and a portion of said lens mounting element.

15. The method of claim 10, wherein molding an outer shell comprises molding an outer shell over said circuit element and at least partially into said lens mounting element.

16. The method of claim 15, wherein molding an outer shell comprises molding an outer shell into said lens mounting element so as to mechanically secure said outer shell to said lens mounting element.

17. The method of claim 10, wherein said circuit element is mounted at least partially within said lens mounting element, and wherein molding an outer shell comprises molding an outer shell around said circuit element and at least partially within said lens mounting element to substantially encapsulate said circuit element within said lens mounting element.

18. The method of claim 17, wherein said circuit element includes a wire harness extending therefrom, and wherein molding an outer shell comprises molding an outer shell around a connector portion of said wire harness to substantially encapsulate said connector portion of said wire harness within said outer shell.

19. The method of claim 10, wherein said circuit element includes a wire harness extending therefrom, and wherein molding an outer shell comprises molding an outer shell around a connector portion of said wire harness to substantially encapsulate said connector portion of said wire harness within said outer shell.
